(19) United States
(12) Patent Application Publication
(10) Pub. No.: US 2002/0047614 A1
(43) Pub. Date: Apr. 25, 2002

(54) Fluorescent lamp circuit structure

(76) Inventor: Yung-Chuan Lin, Junghe (TW)

Correspondence Address: OPPENHEIMER WOLFF & DONNELLY LLP, P.O. BOX 52037, Palo Alto, CA, 94306, US

(21) Appl. No.: 09/955,627

(22) Filed: Sep. 18, 2001

(30) Foreign Application Priority Data
Sep. 21, 2000 (TW) 89216386

(51) Int. Cl. H05B 41/16

(52) U.S. Cl. 315/247; 315/224

(57) ABSTRACT

A fluorescent lamp circuit structure includes an isolated type direct current supply independent structure connected to isolated type fluorescent lamp electronic lighting circuits of fluorescent lamps at a far end via a distribution line. The isolated type direct current supply structure is commonly used by a plurality of isolated type fluorescent lamp electronic lighting circuits.

### BACKGROUND OF THE INVENTION

(a) Field of the Invention:

The present invention relates to a fluorescent lamp structure, more particularly to an economical, safe circuit structure that can provide high quality direct current, that is simple to install, that can dissipate heat efficiently, that is convenient to maintain, that can enhance power factor of fluorescent lamps, and that can prevent electric resonance interference.

(b) Description of the Prior Art:

Energy saving and environmental protection are global issues. The use of energy saving lamps can help conserve energy, and fluorescent lamps are extensively used for lighting purposes. Fluorescent lamps must be used in conjunction with starting circuits, and conventionally, they are used in conjunction with conventional inductive type stabilizing circuits, which entail the following major disadvantages:

1. Inductive type stabilizing circuits are relatively bulky and may generate high temperature, which is not safe when mounted on lamps.

2. The speed of starting is slow.

3. The rate of flickering is about 20%.

4. The lighting efficiency is not ideal.

Therefore, there have been developed electronic ballast circuits for fluorescent lamps. Referring to FIGS. 1 and 2, a conventional electronic ballast circuit (A) includes a direct current power supply circuit (B) (bridge rectifier) and an electronic lighting circuit (C), which are directly mounted on the fluorescent lamp. However, there are the following problems associated with the use of the conventional electronic ballast circuit (A)

1. Electronic circuits have problems of heat dissipation.

2. Circuits are not readily accessible for maintenance when the lamp is mounted at a relatively high position.

3. Maintenance of circuits is through replacement of all the circuits, which is not economical or environmental friendly.

4. Power factor is still relatively low.

5. There is the problem of electric current resonance interference.

### SUMMARY OF THE INVENTION

Therefore, the primary object of the present invention is to provide a fluorescent lamp circuit structure, in which a high quality direct current supply circuit structure for common use by a plurality fluorescent lamps is isolated for direct and convenient mounting on an alternating current power for lighting purposes.

Another object of the present invention is to provide an isolated electronic lighting circuit that can be conveniently installed on fluorescent lamps.

### BRIEF DESCRIPTION OF THE DRAWINGS

The foregoing and other features and advantages of the present invention will be more clearly understood from the following detailed description and the accompanying drawings, in which,

FIG. 1 illustrates a conventional electronic ballast circuit of a fluorescent lamp;

FIG. 2 is a function block diagram of the conventional electronic ballast circuit;

FIG. 3 is a schematic view of the preferred embodiment of a fluorescent lamp circuit structure according to the present invention as a far end isolated type;

FIG. 4 is a circuit diagram of a high quality direct current supply circuit for common use by a plurality of fluorescent lamps;

FIG. 5 is a function block diagram of the high quality direct current supply circuit for common use by a plurality of fluorescent lamps;

FIG. 6 is a circuit diagram of an isolated type fluorescent lamp lighting circuit according to the present invention; and

FIG. 7 is a function block diagram of the isolated type fluorescent lamp lighting circuit according to the present invention.

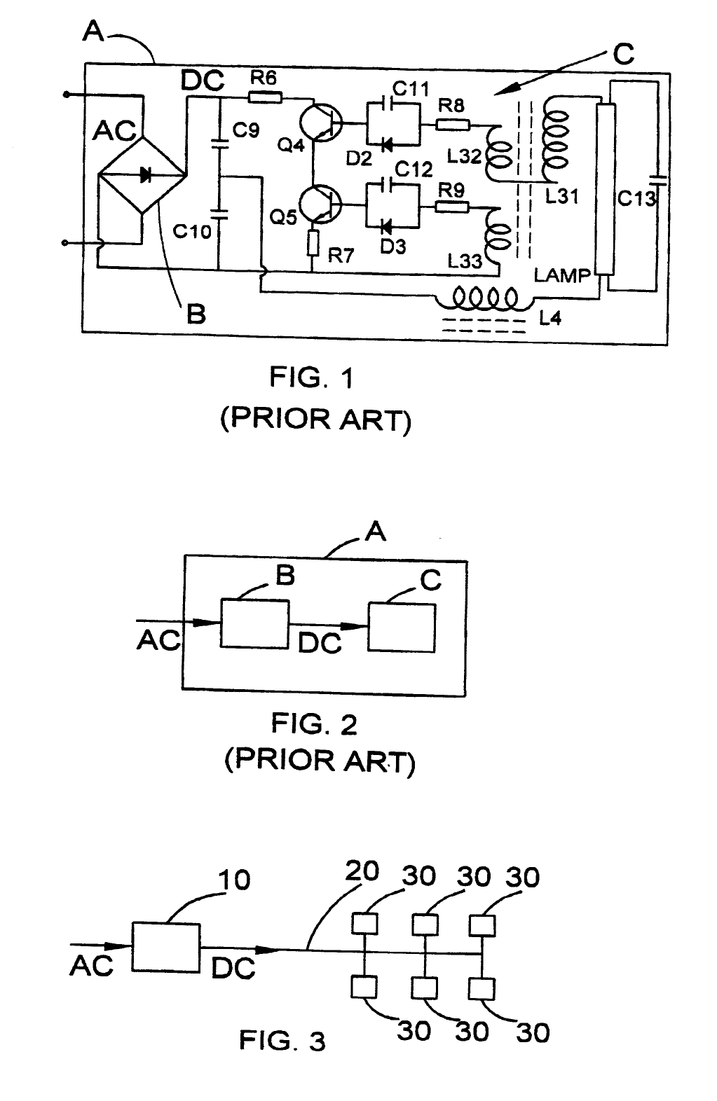

### DETAILED DESCRIPTION OF THE PREFERRED EMBODIMENT

Referring to FIG. 3, in the preferred embodiment of a fluorescent lamp circuit structure according to the present invention, a direct current supply circuit is isolated into an independent structure 10, and is connected via a distribution line 20 to isolated type electronic lighting circuits 30 on fluorescent lamps located at a far end position. The direct current independent structure 10 is upgradable to supply high-quality direct current for use by a plurality of fluorescent lamps in an economical manner. The isolated type fluorescent lamp electronic lighting circuits 30 are provided with high-frequency isolation induction circuits 31 for preventing occurrence of electric resonance interference.

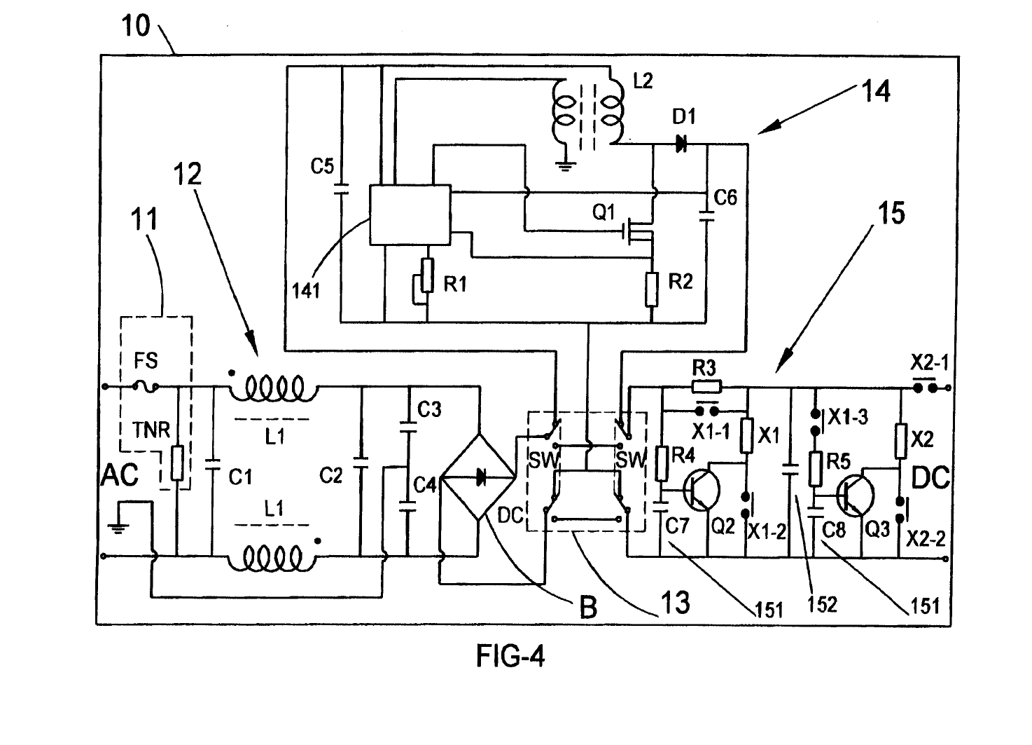

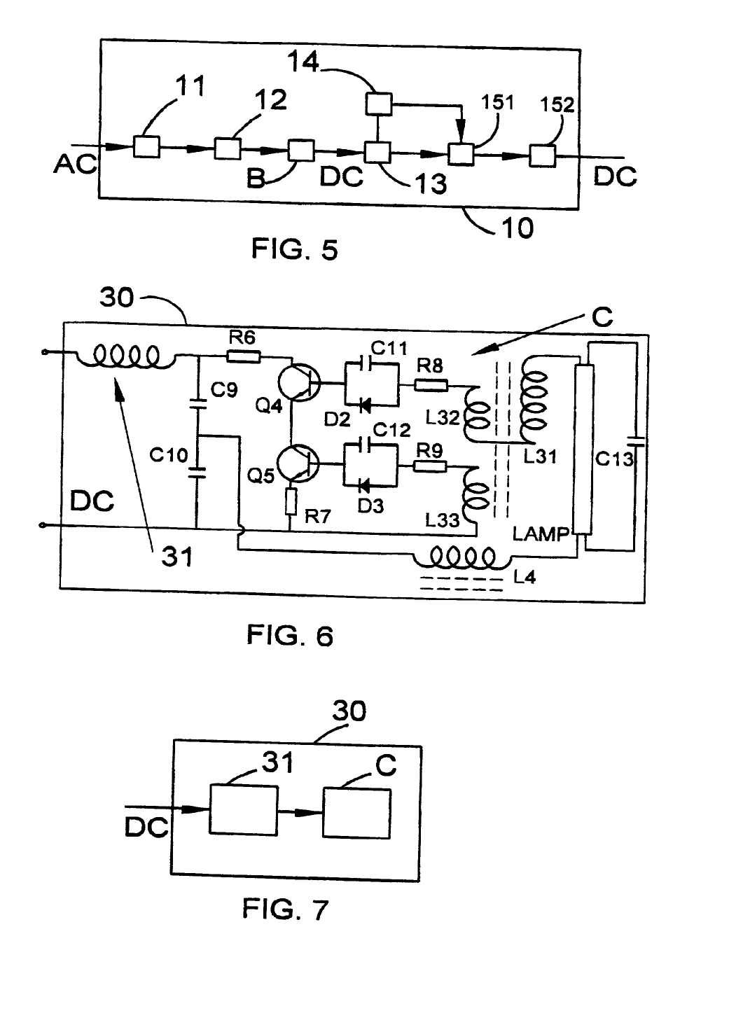

Referring to FIGS. 4 and 5, the isolated type direct current independent structure 10 includes a bridge rectifier (B) having an over-current and overvoltage protection circuit 11, which is formed by a fuse (FS) and a pressure-sensitive resistor (TNR), and an anti-magnetic interference circuit 12, which is formed by an inductor and a capacitor network, disposed at an anterior stage thereof. The posterior stage of the bridge rectifier (B) is provided with a function switching on-off circuit 13, a power factor rectifying filter circuit 14 comprising mainly of a power factor rectifying integrated circuit 141, and a large electrolytic capacitor control circuit 15, which is formed by a delay circuit 151 and a large electrolytic capacitor 152.

As the anti-magnetic interference circuit 12 and the power factor rectifying filter circuit 14 are known in the art, a detailed description thereof is dispensed with herein for the sake of brevity.

The over-current and over-voltage protection circuit 11 is formed by a fuse (FS) connected in cascade at the foremost stage of the input of alternating current, and a pressure-sensitive resistor (TNR) connected in parallel disposed immediately after the fuse. The principle of operation thereof as regards overcurrent is similar to that in conventional fuses, in which the fuse will melt when the current therein is excessive to open the circuit. This circuit is characterized in that when an over-voltage occurs, the resistance of the pressure-sensitive resistor (TNR) will become small, forming a zero-resistance circuit. Then the electric power is automatically switched and passes through the pressure-sensitive resistor (TNR) so that a short circuit occurs, thereby causing the fuse (FS) to melt due to excessive current therein and to thereby open the circuit.

Furthermore, in the present invention, the function switching on-off circuit 13 provided at the anterior stage of the power factor rectifying filter circuit 14 is disposed for selective switching by the user to connect or disconnect the power factor rectifying filter circuit 14 to or from between the bridge rectifier circuit (B) and the large electrolytic capacitor control circuit 15. In a power system environment that does not require power rectification, this circuit can be used and switched to enable the power factor rectifying filter circuit 14 to rest to thereby prolong the service life of the circuit. When the power factor rectifying filter circuit 14 malfunctions, the circuit can be cut off so that the bridge rectifier circuit (B) is directly connected to the large electrolytic capacity control circuit 15.

In the large electrolytic capacity control circuit 15, the delay circuit 151 is formed by two delay circuits disposed at the pre-stage and post-stages of the large electrolytic capacitor 152.

The first delay circuit at the anterior stage includes a current limiting resistor (R3), and a delay switch circuit formed by resistor (R4), capacitor (C7) and transistor (Q2), and relay X1, to limit the flow and speed of electric current during charging of the large electrolytic capacitor 152 at the initialization of the circuit so as to maintain safety of the circuit.

The second delay circuit at the posterior stage of the large electrolytic capacitor 152 is essentially a delay switch circuit formed by a resistor (R5), capacitor (C8) and transistor (Q3), and relay X2, to control output of direct current.

The operating principle of the delay circuit 151 is described hereinbelow. When the circuit is initiated and the bridge rectifier (B) and/or power factor rectifying filter circuit 14 output direct current, the large electrolytic capacitor 15 is first subjected to the current limiting function of the resistor (R3) so that the large electrolytic capacitor 15 can be slowly charged with a small current in a relatively safe manner. When the delay setting of the R4C7 circuit is complete, the transistor (Q2) is connected, and the relay (XI) is thereafter connected. Then the normal on contacts (X 1-1), (X 1-2), (X 1-3) of the relay (X1) couple, in which the coupling of the contact (X 1-1) directly achieves a connection straddling the resistor (R3), so that direct current charges the large electrolytic capacitor 152 directly and smoothly. The coupling of the normal on contact (X 1-2) automatically maintains connection of the relay (X1). The coupling of the normal on contact (X 1-3) achieves simultaneous connection of the R5C8 timing circuit of the second delay circuit. After completion of charging of the large electrolytic capacitor 152, the R5C8 timing circuit will automatically start predetermined delay counting. When the capacitor C8 completes charging and starts discharging, the transistor (Q3) can be connected and the relay (X2) can also be connected. At this time, the normal on contact (X 2-1) opens the path to output direct current, while the normal on contact (X 2-2) enables the relay (X2) to automatically maintain connection. At this time, the large electrolytic capacitor 152 can provide a stable, high-quality direct current output. By virtue of the distribution line 20 shown in FIG. 3, the direct current output is sent to the respective isolated type fluorescent lamp electronic lighting circuit 30 to generate safe and energy saving lighting.

The circuit output capacity of the isolated type direct current independent structure 10 according to the present invention can be designed with flexibility, but preferably in conjunction with ampere values of a conventional alternating current lighting power source or a lighting loop, e.g., in units of 3A, 5A, 8A, 10a, 15A, 20A . . . , which will be convenient. It is noted that the use of a plurality of isolated type direct current independent structures 10 in series is within the scope of the present invention.

Referring to FIGS. 5 and 6, the isolated type fluorescent lamp electronic lighting circuit 30 according to the present invention is shown to be an integral structure formed by a high-frequency isolation induction circuit 31 connected in cascade anterior to a conventional electronic lighting circuit (C), and is adapted to be used in conjunction with a conventional fluorescent lamp to thereby achieve advantages of compactness and economy. If the circuit is used in conjunction with compact energy saving lamp products (including 2U, 3U, 4U, . . . and enclosure-type), it will have advantages of simple circuitry, lightweight, low heat radiation, good heat dissipation, and low cost.

In view of the arrangement of the high-frequency isolation induction circuit 31 anterior to the conventional electronic lighting circuit (C) in the respective isolated type fluorescent lamp electronic lighting circuit 30 according to the present invention, the isolated type fluorescent lamp electronic lighting circuit 30 can indeed prevent occurrence of electric resonance interference effectively.

The present invention provides an isolated type direct current management system for fluorescent lamps to enable the direct current supply circuit to become an isolated structure, which can be used in conjunction with heat-dissipating metal structures and/or heat-dissipating fans, or can be arranged in a good ventilated or low temperature environment to enhance the heat-dissipating efficiency. With enhanced heat-dissipating efficiency and under good spatial conditions, function circuits to stabilize electric power quality can be added to achieve high power factor and high quality direct current for output to lamps, thereby saving energy.

In sum, by isolating the direct current supply circuit for use by a plurality of fluorescent lamps, energy can be conserved. Besides, the circuit structure can be installed at a suitable position that can facilitate maintenance and that permits good heat dissipation to reduce rate of malfunctioning. In addition, the circuit structure provides sufficient space to permit expansion of circuit functions so as to achieve enhanced power factor, and to facilitate maintenance of the circuits or components therein. Furthermore, the circuit structure is provided with a delay protection circuit to prevent damage to the circuits and the fluorescent lamps due to sudden surge at the instant when several lamps are simultaneously switched on. The isolated electronic lighting circuit, when adapted for use in fluorescent lighting fixtures or energy saving lamps, provides advantages of compactness, safety, and economy. Besides, with a reduction in the number of heat-generating components, the heat dissipating effect is improved to reduce occurrence of malfunctioning. In addition, costs can be reduced. Furthermore, a high-frequency isolation circuit can be added to prevent resonance interference or distortion.

Although the present invention has been illustrated and described with reference to the preferred embodiment thereof, it should be understood that it is in no way limited to the details of such embodiment but is capable of numerous modifications within the scope of the appended claims.

What is claimed is:

1. A fluorescent lamp circuit structure, comprising an isolated type direct current supply independent structure connected to isolated type fluorescent lamp electronic lighting circuits of one or more fluorescent lamps at a far end via one or more distribution lines, said isolated type direct current supply structure being commonly used by a plurality of isolated type fluorescent lamp electronic lighting circuits.

2. The fluorescent lamp circuit structure as claimed in claim 1, wherein said isolated type direct current supply independent structure includes an over-current and over-voltage protection circuit disposed therein and formed by a fuse and a pressure-sensitive resistor connected anterior to a direct current input end.

3. The fluorescent lamp circuit structure as claimed in claim 1, wherein said isolated type direct current supply independent structure includes an anti-magnetic interference circuit disposed at a post-stage of said over-current and over-voltage protection circuit.

4. The fluorescent lamp circuit structure as claimed in claim 1, wherein said isolated type direct current supply independent structure includes a power factor rectifying filter circuit disposed at a post-stage of a bridge rectifier circuit.

5. The fluorescent lamp circuit structure as claimed in claim 1, wherein said isolated type direct current supply independent structure includes a large electrolytic capacitor control circuit disposed at a rearmost stage thereof.

6. The fluorescent lamp circuit structure as claimed in claim 1, wherein said isolated type direct current supply independent structure includes a function switching on-off circuit to permit the user to selectively switch the power factor rectifying filter circuit on to or off from between said bridge rectifier circuit and said large electrolytic capacitor control circuit, or to permit direct switching of said bridge rectifier on to or off from said large electrolytic capacitor control circuit.

7. The fluorescent lamp circuit structure as claimed in claim 5, wherein said large electrolytic capacitor control circuit is formed by a delay circuit and a large electrolytic capacitor.

8. The fluorescent lamp circuit structure as claimed in claim 5, wherein said delay circuit of said large electrolytic capacitor control circuit has a two-stage delay control function, charging of said large electrolytic capacitor being controlled in the first stage of delay control to be at a suitably small current in a safe manner, and the second stage of delay control being conducted after completion of charging of said large electrolytic capacitor to ensure output of high quality direct current for use by fluorescent lamp electronic lighting circuits.

9. The fluorescent lamp circuit structure as claimed in claim 1, wherein said isolated direct current supply structure can be adapted to be mounted in any type of compact energy saving lamps.

10. The fluorescent lamp circuit structure as claimed in claim 1, wherein said isolated type fluorescent lamp electronic lighting circuit includes a high-frequency isolation inductor circuit.

11. A direct current supply independent structure comprises an over-current and over-voltage protection circuit, an anti-magnetic interference circuit, a bridge rectifier circuit, a switching function on-off circuit, a power factor rectifying filter circuit, and a large electrolytic capacitor control circuit, adapted for use by a plurality of fluorescent lamp electronic lighting circuits, a large electrolytic capacitor thereof having a safe current-limiting slow charging function.

12. An isolated type fluorescent lamp electronic lighting circuit structure comprising a direct current supply circuit which is isolated from said circuit structure so that said circuit structure has advantages of simplicity, compactness, durability and economy.
